(19) United States
(12) Patent Application Publication
(10) Pub. No.: US 2010/0167099 A1
(43) Pub. Date: Jul. 1, 2010

(54) MEMBRANCE ELECTRODE ASSEMBLY (MEA) STRUCTURE AND MANUFACTURING METHOD THEREOF

(75) Inventors: Lung-Yu Sung, Kaohsiung City (TW); Chun-Hsing Wu, Taipei City (TW); Kan-Lin Hsueh, Hsinchu County (TW)

Correspondence Address: QUINTERO LAW OFFICE, PC, 615 Hampton Dr, Suite A202, Venice, CA, 90291, US

(73) Assignee: INDUSTRIAL TECHNOLOGY RESEARCH INSTITUTE, Hsinchu (TW)

(21) Appl. No.: 12/472,334

(22) Filed: May 26, 2009

(30) Foreign Application Priority Data
Dec. 31, 2008 (TW) TW097151798

(51) Int. Cl. H01M 8/10; B05D 5/12

(52) U.S. Cl. 429/30; 427/115

(57) ABSTRACT

A membrane electrode assembly (MEA) structure includes a proton exchange membrane having opposite first and second sides, a cathode catalyst layer disposed at the first side of the proton exchange membrane, an anode catalyst layer disposed at the second side of the proton exchange membrane, a first composite gas diffusion layer disposed at the first side of the proton exchange membrane and adjacent to the cathode catalyst layer, including a first gas diffusion substrate layer and a first micro-porous layer disposed between the first gas diffusion substrate layer and the cathode catalyst layer, and a second composite gas diffusion layer disposed at the second side of the proton exchange membrane and adjacent to the anode catalyst layer, including a second gas diffusion substrate layer and a second micro-porous layer disposed between the second gas diffusion substrate layer and the anode catalyst layer.

This Application claims priority of Taiwan Patent Application No. 97151798, filed on Dec. 31, 2008, the entirety of which is incorporated by reference herein.

### BACKGROUND OF THE INVENTION

1. Field of the Invention

The invention relates to main elements applied to a fuel cell, and more particularly to a membrane electrode assembly (MEA) structure applied in a fuel cell and manufacturing methods thereof which allows for higher carbon monoxide (CO) tolerances and lower humidification level of reaction fluids applied thereto.

2. Description of the Related Art

Fuel cells are power converting devices for transforming chemical energy to electrical energy. Fuel cells emit lower pollutants, are quiet, and provide higher energy density and higher energy converting efficiency compared to conventional power generating techniques. Fuel cells are considered to be a clean energy source suitable for future applications such as portable electronic devices, household electric power generating systems, transportation vehicles, military equipment, space industrial equipment and large-scale electric power generating systems.

There are substantially six types of fuel cells such as a phosphoric acid fuel cell (PAFC), a molten carbonate fuel cell (MCFC), a solid oxide fuel cell (SOFC), an alkaline fuel cell (AFC), a proton exchange membrane fuel cell (PEMFC), and a direct methanol fuel cell (DMFC) which are defined according to electrolytes used therein. The fuel cells can be applied to various applications based on capacity, electrical power-generating efficiency and electrical power-generating characteristic requirements of the fuel cell.

The proton exchange membrane fuel cell (PEMFC) has advantages such as low operating temperature, quick switch-on, and high energy density. It has been recently developed and applied to various applications, thereby having a highly commercial value.

Referring to FIG. 1, a conventional proton exchange membrane fuel cell (PEMFC) 10 is partially illustrated. Herein, the fuel cell 10 is illustrated with an anode gas channel plate 22, an anode gas diffusion layer 18, an anode catalyst layer 14, a proton exchange membrane 12, a cathode catalyst layer 16, a cathode gas diffusion layer 20, and a cathode gas channel plate 26, sequentially stacked on opposite sides of the proton exchange membrane 12. The proton exchange membrane 12, the anode catalyst layer 14, the cathode catalyst layer 16, the anode gas diffusion layer 18 and the cathode gas diffusion layer 20 compose a membrane electrode assembly MEA of the fuel cell 10. The membrane electrode assembly MEA is a key element of the fuel cell 10 which directly effects electrical power generating efficiency. Therefore, one or more than one membrane electrode assembly MEA can be integrated to form the fuel cell 10 such that voltage and current requirements thereof are met. Moreover, a plurality of fluid channels 24 and 28 are provided in the anode gas channel plate 22 and the cathode gas channel 26, respectively adjacent to the anode gas diffusion layer 18 and the cathode gas diffusion layer 20, to supply suitable reaction fluids from an anode side 50 and a cathode side 60 to the membrane electrode assembly MEA, thereby generating electrical power by conversion reaction provided from the membrane electrode assembly MEA.

During operation of the fuel cell 10, a hydrogen oxidation reaction occurs at the anode side 50 and an oxygen reduction reaction occurs at the cathode side 60. Main reaction formulas in the fuel cell 10 are described as follows:

At the anode: H₂→2H⁺+2e⁻; Formula (1)

At the cathode: (½) O₂+2H⁺+2e⁻→H₂O; and Formula (2)

Overall reaction: H₂+(½)O₂→2H₂O. Formula (3)

According to the above Formula (1), the reaction fluids at the anode side 50 is catalyzed by the anode catalyst layer 14 and is decomposed into hydrogen ions (H⁺) and electrons (e⁻). The electrons flow to the cathode side through an outer circuit (not shown) and a load element (not shown). According to the above Formula (2), the formed hydrogen ions (H⁺) passes to the cathode side 60 from the anode side 50 by the proton exchange membrane 12. Herein, the hydrogen ions (H⁺) and the electrons (e⁻) combine with the oxygen molecular (O₂) flowing through the cathode catalyst layer 16 such that water at the cathode side 60 is formed. Thus, the reaction of the fuel cell 10 is described as an overall reaction of reacting hydrogen with oxygen for forming water.

As the hydrogen ions are generated at the anode side 50 of the fuel cell 10, the hydrogen ions continuously pass to the cathode side 60 by conduction, wherein for hydrogen ion conduction, a plurality of water hydrates are required (e.g. being conducted as a hydrate form H⁺(H₂O)ₙ). Therefore, if moisture is not supplied to the layers (e.g. the anode catalyst layer 14 and/or the anode gas diffusion layer 18) at the anode side 50 on time, the moisture content in the proton exchange membrane 12 will reduce, causing electrical power generating efficiency of the fuel cell 10 to reduce.

Moreover, water is generated at the cathode side 60 of the fuel cell 10 due to the reduction reaction of the oxygen and most of the water may pass through the porous cathode gas diffusion layer 20 and are drained by the fluid channels 28. Portions of the water, however, are reversely diffused back to the proton exchange membrane 12 and are accumulated at the cathode gas diffusion layer 20 to cause cathode flooding, thereby blocking passages for the reaction fluids at the cathode side 60 and reducing the electrical power generating efficiency of the fuel cell 10.

Moreover, pure oxygen gas or air is typically utilized as reaction fluids at the cathode side 60 of the fuel cell 10. Since air is composed of about 21% oxygen and 79% nitrogen gas and only the oxygen therein participate in the reaction, a reaction fluid flow rate of five times that or more of pure oxygen must be used. Therefore, due to the high flow rate, electrical power generating efficiency of the fuel cell 10 is negatively affected. Thus, for the proton exchange membrane 12 to perform with good electrical power generating efficiency, full humidification levels are needed for the reaction fluids at the anode side 50 and the cathode side 60, to maintain proper moisture contents of the proton exchange membrane 12 under a saturated situation.

In addition, pure hydrogen or reformate gas is typically provided at the anode side 50 of the fuel cell 10 as reaction fluids. The pure hydrogen can be provided from a pressured hydrogen source, liquefied hydrogen source or a hydrogen storage tank having relatively low impurities therein. The reformate gases, are obtained by processing hydrogencarbon in a reformer comprising a hydrogen gas content of about 35%-75% and other impurities such as carbon dioxide (CO₂), nitrogen (N₂), water and carbon monoxide (CO). Since the anode catalyst layer 14 of the fuel cell 10 is typically formed of catalyst materials such as platinum (Pt) which is easily absorbed with the carbon monoxide in the reformate gases, catalyst activity may be lost. Specifically, the anode catalyst layer 14 may become poisoned and fail to oxidize and form the hydrogen ions.

Thus, a membrane electrode assembly (MEA) structure applied in a fuel cell and manufacturing methods thereof which allows for higher carbon monoxide (CO) tolerances and lower humidification level of reaction fluids applied thereto are desired, such that operating lifespan and electrical power generating efficiency of the fuel cells is increased.

### BRIEF SUMMARY OF THE INVENTION

The invention provides a membrane electrode assembly (MEA) structure and manufacturing methods thereof for addressing the above issues of the conventional art.

An exemplary embodiment of a membrane electrode assembly (MEA) structure comprises a proton exchange membrane having opposite first and second sides, a cathode catalyst layer disposed at the first side of the proton exchange membrane, an anode catalyst layer disposed at the second side of the proton exchange membrane, and a first composite gas diffusion layer disposed at the first side of the proton exchange membrane and adjacent to the cathode catalyst layer, wherein the first composite gas diffusion layer comprises a first gas diffusion substrate layer and a first micro-porous layer disposed between the first gas diffusion substrate layer and the cathode catalyst layer, and a second composite gas diffusion layer is disposed at the second side of the proton exchange membrane and adjacent to the anode catalyst layer. The second composite gas diffusion layer comprises a second gas diffusion substrate layer and a second micro-porous layer disposed between the second gas diffusion substrate layer and the anode catalyst layer.

An exemplary embodiment of a method for manufacturing a membrane electrode assembly (MEA) structure comprises providing a proton exchange membrane having opposite first and second sides. A first composite gas diffusion layer is provided and disposed at the first side of the proton exchange membrane, wherein the first composite gas diffusion layer comprises a first gas diffusion substrate layer and a first micro-porous layer. A cathode catalyst layer is formed over the first micro-porous layer of the first composite gas diffusion layer. A second composite gas diffusion layer is provided and disposed at the second side of the proton exchange membrane, wherein the second composite gas diffusion layer comprises a second gas diffusion substrate layer and a second micro-porous layer. An anode catalyst layer is formed over the second micro-porous layer of the second composite gas diffusion layer. The first composite gas diffusion layer, the cathode catalyst layer, the proton exchange membrane, the anode catalyst layer and the second composite gas diffusion layer are thermally compressed to form the MEA structure.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing a conventional proton exchange membrane fuel cell (PEMFC);

FIG. 2 is a schematic diagram showing a fuel cell according an embodiment of the invention;

FIG. 3 is a schematic diagram showing a fuel cell according another embodiment of the invention; and

FIG. 4 is a schematic diagram showing a fuel cell according yet another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

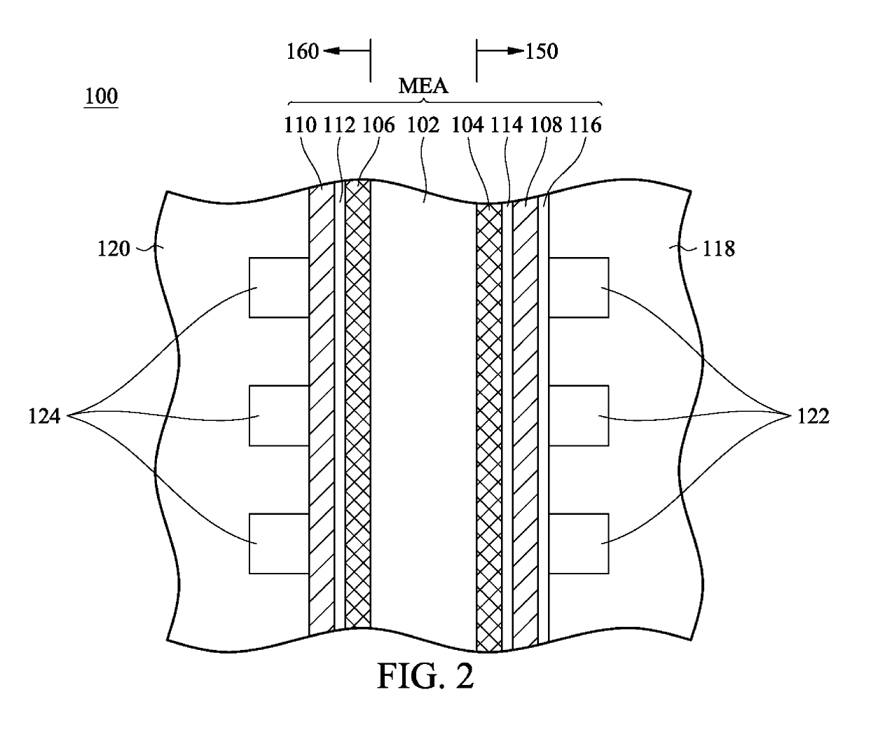

FIGS. 2-4 are schematic diagrams illustrating various exemplary membrane electrode assembly structures applicable in a fuel cell.

As shown in FIG. 2, an exemplary fuel cell 100 is illustrated. Herein, the fuel cell 100 is illustrated with main components such as an anode gas channel plate 118, an anode gas diffusion layer, an anode catalyst layer 104, a proton exchange membrane 102, a cathode catalyst layer 106, a cathode gas diffusion layer, and a cathode gas channel plate 120 sequentially stacked on opposite sides of the proton exchange membrane 102. Herein, the anode gas diffusion layer and the cathode gas diffusion layer are composite layers, wherein the anode gas diffusion layer comprises an anode gas diffusion substrate layer 108, a micro-porous layer 114 and a carbon monoxide (CO) conversion catalyst layer 116, and the cathode gas diffusion layer comprises a cathode gas diffusion substrate layer 110 and a micro-porous layer 112.

In this embodiment, components including the proton exchange membrane 102, the anode catalyst layer 104, the cathode catalyst layer 106, the anode gas diffusion layer, and the cathode gas diffusion layer compose a membrane electrode assembly MEA for the fuel cell 100. As shown in FIG. 2, one or more than one membrane electrode assembly MEA can be integrated to form the fuel cell 100 such that voltage and current requirements thereof are met.

Still referring to FIG. 2, a plurality of fluid channels 122 and 124 are provided in the anode gas channel plate 118 and the cathode gas channel plate 120, respectively adjacent to the anode gas diffusion layer and the cathode gas diffusion layer, to supply suitable reaction fluids from an anode side 150 and a cathode side 160 to the membrane electrode assembly MEA, thereby generating electrical power by conversion reaction performed by the membrane electrode assembly MEA.

As shown in FIG. 2, in the components formed at the cathode side 160 of the membrane electrode assembly MEA of the fuel cell 100, the cathode gas diffusion substrate layer 110 is treated by a hydrophobic process and a thermal process (both not shown), thus showing a hydrophobic property and allowing gas penetration. In addition, the micro-porous layer 112 between the cathode gas diffusion substrate layer 110 and the cathode catalyst layer 106 is formed with micropores of a diameter of about 0.03-0.5 μm and shows a relatively higher hydrophobic property than that of the cathode gas diffusion substrate layer 110. Thus, the cathode gas diffusion layer composed of the cathode gas diffusion substrate layer 110 and the micro-porous layer 112 shows a suitable hydrophobic property and allows gas penetration such that moisture-blocking and moisture-preserving effects are present. The water generated at the cathode side 160 can be reversely diffused to the proton exchange membrane 102 to ensure that the water content therein maintained at a defined saturated level is reached. Therefore, the humidification level of the reaction fluids at the cathode side 160 of the fuel cell 100 can be reduced from conventional full humidification to relative low humidification or even non humidification, thereby simplifying or reducing use of a humidification system (not shown) which may applied in the fuel cell 100 for humidifying the reaction fluids.

Still referring to FIG. 2, the anode gas diffusion substrate layer 108 formed at the anode side 150 of the membrane electrode assembly MEA of the fuel cell 100 is also treated by a hydrophobic process and thermal process (both not show), thus showing a hydrophobic property and allowing gas penetration. In addition, the micro-porous layer 114 formed between the anode gas diffusion substrate layer 108 and the anode catalyst layer 114 is formed with micropores of a diameter of about 0.03-0.5 μm and shows a relative high hydrophobic property than that of the anode gas diffusion substrate layer 108. Thus, the anode gas diffusion layer composed of the anode gas diffusion substrate layer 108 and the micro-porous layer 114 shows a suitable hydrophobic property and allows gas penetration such that provides effects such as moisture-blocking and moisture-preserving. Therefore, the humidification level of the reaction fluids at the anode side 150 of the fuel cell 100 can be reduced from the conventional full humidification to lower or even no humidification, thereby simplifying or reducing use of a humidification system (not shown) which may be applied in the fuel cell 100 for humidifying the reaction fluids. Moreover, in this embodiment, the CO conversion catalyst layer 116 disposed between the anode gas diffusion substrate layer 108 and the adjacent anode gas channel plate 118 converses the carbon monoxide contents in the reaction fluids such as the hydrogen-containing reformate gases provided from the fluid channels 122 in the anode gas channel plate 118 into carbon dioxide, thereby reducing or even preventing poisoning issues from occurring in the anode catalyst layer 104. A carbon monoxide conversion reaction achieved by the CO conversion catalyst layer 116 is described in Formulas 4 and 5 as follows:

CO+½O₂→CO₂ and; Formula (4)

CO+H₂O→CO₂+H₂. Formula (5)

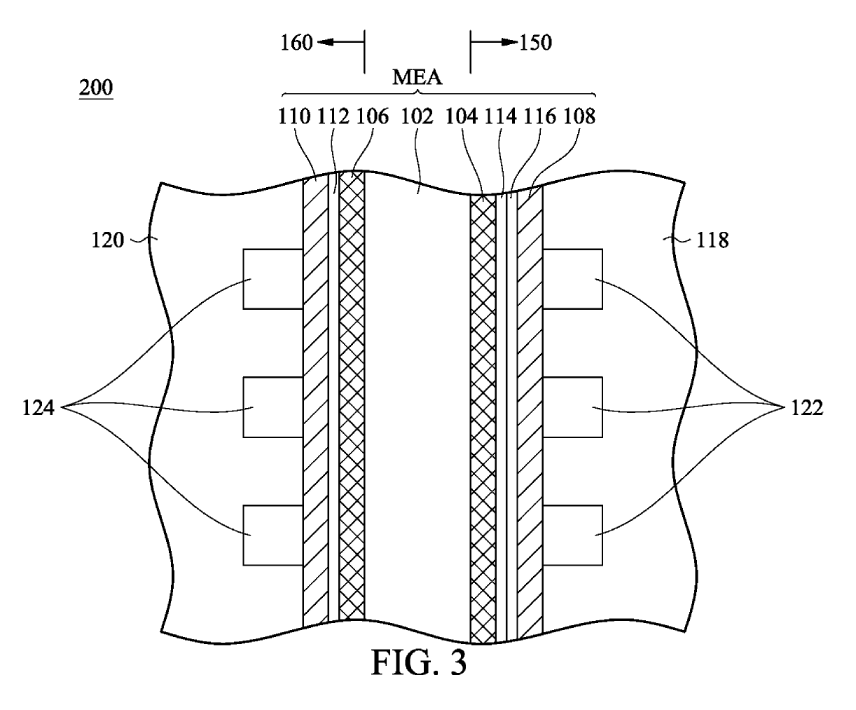

As shown in FIG. 3, another exemplary fuel cell 200 is illustrated. Herein, the fuel cell 200 is modified from the fuel cell 100 illustrated in FIG. 2. In this embodiment, components of the fuel cell 200 are similar with that of the fuel cell 100 and only a difference of the location of the CO conversion catalyst layer 116 exists. In this embodiment, the CO conversion catalyst layer 116 is disposed between the micro-porous layer 114 and the anode gas diffusion substrate layer 108, and the fluid channels 122 disposed in the anode gas channel plate 118 expose portions of the anode gas diffusion substrate layer 108, respectively.

As illustrated by the embodiments shown in FIGS. 2 and 3, the cathode catalyst layer 106 and the anode catalyst layer 104 may comprise materials such as Pt, Ru, Au, Pd, Ni, Rh, C or combinations thereof. The proton exchange membrane 102 can be, for example, a perfluorosulfonic acid polymer layer such as Nafion® (a product of DuPont), Dow® (a product of Dow Chemical), Aciplex® (a product of Asahi Chemical) and Flemion® (a product of Asahi Glass), or a partial fluorosulfonic acid polymer layer such as BAM3G (a product of Ballard). The cathode gas diffusion substrate layer 110 is formed with a porous structure such as a carbon paper or a carbon cloth of a thickness of about 150-600 μm, having a pore diameter of about 1-100 μm and a porosity of about 0.6-0.9. The anode gas diffusion substrate layer 108 is also formed with a porous structure such as a carbon paper or a carbon cloth with a thickness of about 150-600 μm, a pore diameter of about 1-100 μm and a porosity of about 0.6-0.9. The micro-porous layers 112 and 114 are also formed of porous structures and comprise material such as polytetrafluoroethene (PTFE), having a thickness of about 10-100 μm, a pore diameter of about 0.03-0.5 μm, and a porosity of about 0.4-0.9. The CO conversion catalyst layer 116 may comprise materials such as Pt, Ru, Au, Pd, Co, Ni, Cu, Zn or combinations thereof, having a thickness of about 10-100 μm, a pore diameter of about 0.03-0.5 μm, and a porosity of about 0.4-0.9.

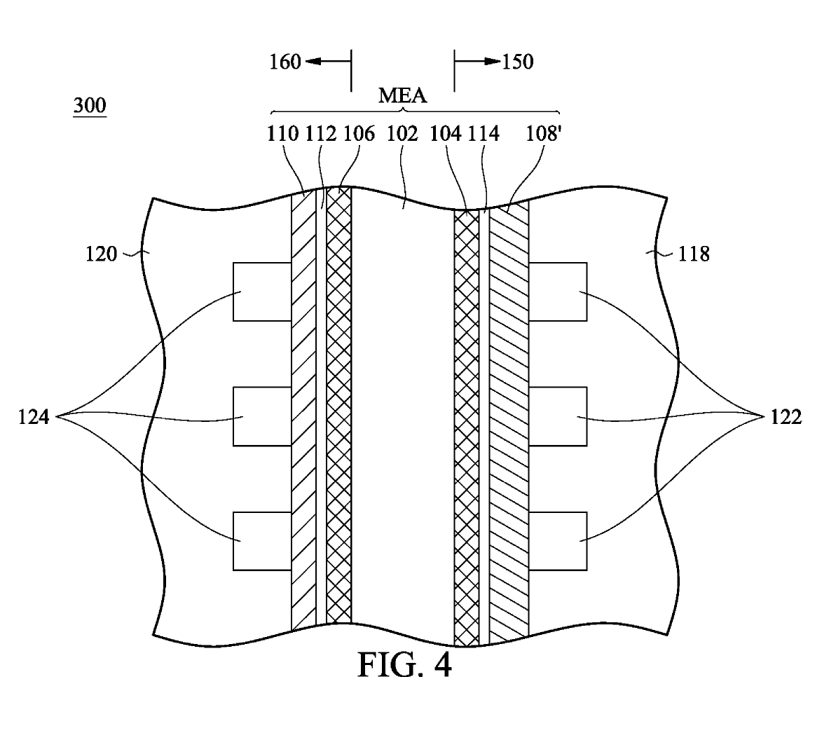

Referring to FIG. 4, yet another exemplary fuel cell 300 is illustrated. Herein, the fuel cell 300 shown in FIG. 4 is modified from the fuel cell 100 shown in FIG. 2. Components used in the fuel cell 300 are similar with that of the fuel cell 100. However, the anode gas diffusion substrate 108′ of the fuel cell 300 is different from the anode gas diffusion substrate 108 of the fuel cell 100. Compared with that illustrated in FIG. 2, in this embodiment, the porous anode gas diffusion substrate layer is first immersed into the CO conversion catalyst materials to deposit the CO conversion catalyst materials thereover, which simplifies the structure of the anode gas diffusion layer. In this embodiment, the anode gas diffusion substrate layer 108′ is also formed with a porous structure such as a carbon paper or carbon cloth with a thickness of about 150-600 μm, a pore diameter of about 1-100 μm and a porosity of about 0.6-0.9. The CO conversion catalyst materials deposited on the anode gas diffusion substrate layer 108′ can be, for example, Pt, Ru, Au, Pd, Co, Ni, Cu, Zn or combinations thereof.

As illustrated in FIGS. 2-4, cathode flooding issues occurring at the cathode side of the fuel cells of the invention can be reduced by improving the hydrophobic property and gas penetration of the gas diffusion layer formed at both the anode side and cathode side, and the water generated at the cathode can be reversely diffused back to the proton exchange membrane by disposing a micro-porous layer having micropores of highly hydrophobic property, thereby reducing or even preventing humidification for the reaction fluids. In addition, a CO conversion catalyst layer can be additionally disposed at the anode side to reduce or even prevent poisoning of the anode catalyst layer.

Embodiments of fabrication of the membrane electrode assembly MEA of the fuel cell of the invention illustrated in FIGS. 2-4 are described below.

Fabrication of the cathode gas diffusion layer shown in FIGS. 2-4 is described as bellow:

The cathode gas diffusion substrate layer 110 is first immersed into a polytetrafluoroethene (PTFE) containing solution with a PTFE concentration of about 1-10 wt % until a defined saturated level is reached and then dried and thermally treated (e.g. thermally treated under a temperature of 300-400° C. for 30 minutes) to provide hydrophobic property thereof. Next, the micro-porous layer 112 is coated at a side of the cathode gas diffusion substrate layer 110 by the appropriate techniques and then thermally treated (e.g. thermally treated under a temperature of about 350-450° C. for 30 minutes) to form the cathode gas diffusion layer.

Fabrication of the anode gas diffusion layer illustrated in FIGS. 2-3 is the same as that of the cathode gas diffusion layer. In addition to a micro-porous layer 114 coated at a side of the anode gas diffusion substrate layer 108, a CO conversion catalyst layer 116 is optionally coated at an opposite side of the anode gas diffusion substrate layer 108, and the CO conversion catalyst layer 116 is also thermal treated (e.g. thermally treated under a temperature of about 350-450° C. for 30 minutes).

Moreover, fabrication of the cathode catalyst layer 106 and the anode catalyst layer 104 in the membrane electrode assembly MEA is described as bellows:

Metal catalysts are first mixed with a solvent and a disper to form a catalyst ink. The catalyst ink can be stirred and mixed by a stirring machine to improve dispersiveness and adjust viscosity of the catalyst ink. Next, the catalyst ink is coated over the micro-porous layer 112 of the cathode gas diffusion layer and is thermally treated (e.g. thermally treated under a temperature of about 100-140° C. for 30 minutes) to provide the cathode catalyst layer 106. The above catalyst ink can be also coated over the micro-porous layer 114 of the anode gas diffusion layer and is also thermally treated (e.g. thermally treated under a temperature of about 100-140° C. for 30 minutes) to provide the anode catalyst layer 104. The catalyst ink can be coated over both sides of the proton exchange membrane 102 to form the cathode catalyst layer 106 and the anode catalyst layer 104.

The cathode gas diffusion layer including the cathode gas diffusion substrate layer 110, the micro-porous layer 112, the cathode catalyst layer 106, the proton exchange membrane 102, the anode catalyst layer 104, and the anode gas diffusion layer including the anode gas diffusion substrate layer 116 are then thermally compressed to form the membrane electrode assembly MEA of a fuel cell.

Fabrication of the anode gas diffusion layer 108′ illustrated in FIG. 4 is described as follows:

The anode gas diffusion substrate layer 108′ is first immersed into a polytetrafluoroethene (PTFE) containing solution with a PTFE concentration of about 1-10 wt % until a defined saturated level is reached and is then dried and thermally treated (e.g. thermally treated under a temperature of 300-400° C. for 30 minutes) to thereby provide hydrophobic property. Next, the hydrophobic treated anode gas diffusion substrate layer 108′ is immersed into a carbon monoxide (CO) conversion catalyst containing solution until a defined saturated level is reached and is then dried and thermally treated (e.g. thermally treated under a temperature of about 100-300° C. for 30 minutes) to provide CO conversion ability. The anode gas diffusion substrate layer 108′ is thus formed with hydrophobic property and CO conversion ability.

For the above fabrication of the membrane electrode assembly (MEA), the coating techniques used therein can be, for example, doctor knife coating, spread coating, screen coating, die coating, spray coating, electro-deposition techniques. An ink for forming the coated micro-porous layer may comprise, for example, carbon powders, polytetrafluoroethene (PTFE), and dispers. The thermally treated micro-porous layer may have a PTFE content of about 10-40 wt %. Inks for forming the other coated catalyst layers such as the anode catalyst layer, the cathode catalyst layer, and the CO conversion catalyst layer may comprise catalyst powders, binders, dispers, and surfactants, wherein the catalyst powders for forming the cathode and anode catalyst layers can be, for example, Pt, Ru, Au, Pd, Ni, Rh, C or combinations thereof, and the catalyst powders for forming the CO conversion catalyst layer can be, for example, Pt, Ru, Au, Pd, Ni, Rh, C or combinations thereof. The binders can be, for example, polymer binders such as Nafion, PTFE. The dispers can be, for example, organic solvents such as glycerin, propylene glycol, methanol, ethanol, and water. The surfactants can be, for example, Triton. These components can be provided to form the ink being coated over the gas diffusion layer, the micro-porous layer or over the proton exchange membrane. The dispers and the surfactants are then evaporated by normal pressure evaporation or vacuum evaporation. The cathode side components, the proton exchange membrane and the anode side components are then thermally compressed to from the membrane electrode assembly MEA as that illustrated in FIGS. 2-4.

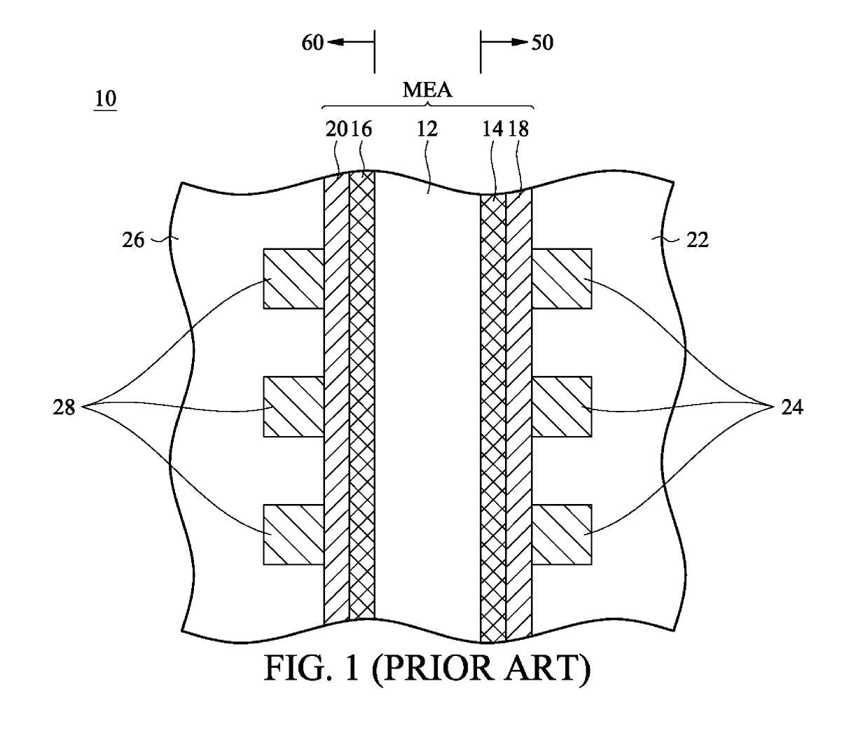

The membrane electrode assembly of the invention has high carbon monoxide tolerance and low fluid humidification for the reaction fluids and prevents cathode flooding issues when compared with the conventional membrane electrode assembly illustrated in FIG. 1. As such operating lifespan of the membrane electrode assembly of the invention used in the fuel cell is increased and operation efficiency of a fuel cell system using the same is improved.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A membrane-electrode assembly (MEA) structure, comprising:
a proton exchange membrane having opposite first and second sides;
a cathode catalyst layer disposed at the first side of the proton exchange membrane;
an anode catalyst layer disposed at the second side of the proton exchange membrane;
a first composite gas diffusion layer disposed at the first side of the proton exchange membrane and adjacent to the cathode catalyst layer, wherein the first composite gas diffusion layer comprises a first gas diffusion substrate layer and a first micro-porous layer disposed between the first gas diffusion substrate layer and the cathode catalyst layer; and
a second composite gas diffusion layer disposed at the second side of the proton exchange membrane and adjacent to the anode catalyst layer, wherein the second composite gas diffusion layer comprises a second gas diffusion substrate layer and a second micro-porous layer disposed between the second gas diffusion substrate layer and the anode catalyst layer.

2. The MEA structure as claimed in claim 1, wherein the second composite gas diffusion layer further comprises a carbon monoxide (CO) conversion catalyst layer, and the CO conversion catalyst layer is disposed between the second micro-porous layer and the second gas diffusion substrate layer.

3. The MEA structure as claimed in claim 1, wherein the second composite gas diffusion layer further comprises a carbon monoxide (CO) conversion catalyst layer, and the CO conversion catalyst layer is disposed at a side of the second gas diffusion substrate layer not contacting with the second micro-porous layer.

4. The MEA structure as claimed in claim 1, wherein the second gas diffusion layer of the second gas diffusion layer is coated with carbon monoxide (CO) conversion catalyst materials.

5. The MEA structure as claimed in claim 1, wherein the cathode catalyst layer and the anode catalyst layer comprise Pt, Ru, Au, Pd, Ni, Rh, C or combinations thereof.

6. The MEA structure as claimed in claim 1, wherein the proton exchange membrane layer comprises a perfluorosulfonic acid polymer layer or a partial fluorosulfonic acid polymer layer.

7. The MEA structure as claimed in claim 1, wherein the first gas diffusion substrate layer comprises a carbon paper or carbon cloth having a thickness of about 150-600 μm.

8. The MEA structure as claimed in claim 1, wherein the first gas diffusion substrate layer is a porous structure having a pore diameter of about 1-100 μm and a porosity of about 0.6-0.9.

9. The MEA structure as claimed in claim 1, wherein the first micro-porous layer comprises polytetrafluoroethene of about 10-40 wt %.

10. The MEA structure as claimed in claim 1, wherein the first micro-porous layer has a thickness of about 10-100 μm.

11. The MEA structure as claimed in claim 1, wherein the first micro-porous layer is a porous structure having a pore diameter of about 0.03-0.5 μm and a porosity of about 0.4-0.9.

12. The MEA structure as claimed in claim 1, wherein the second gas diffusion substrate layer comprises a carbon paper or carbon cloth of about 150-600 μm.

13. The MEA structure as claimed in claim 1, wherein the second gas diffusion substrate layer is a porous structure having a pore diameter of about 1-100 μm and a porosity of about 0.6-0.9.

14. The MEA structure as claimed in claim 2, wherein the second gas diffusion substrate layer comprises polytetrafluoroethene of about 10-40 wt %.

15. The MEA structure as claimed in claim 1, wherein the second micro-porous layer has a thickness of about 10-100 μm.

16. The MEA structure as claimed in claim 1, wherein the second micro-porous layer is a porous structure having a pore diameter of about 0.03-0.5 μm and a porosity of about 0.4-0.9.

17. The MEA structure as claimed in claim 2, wherein the CO conversion catalyst layer comprises Pt, Ru, Au, Pd, Co, Ni, Cu, Zn or combinations thereof.

18. The MEA structure as claimed in claim 2, wherein the CO conversion catalyst layer has a thickness of about 10-100 μm.

19. The MEA structure as claimed in claim 2, wherein the CO conversion catalyst layer is a porous structure having a pore diameter of about 0.03-0.5 μm and a porosity of about 0.4-0.9.

20. The MEA structure as claimed in claim 1, wherein the CO conversion catalyst layer comprises Pt, Ru, Au, Pd, Ni, Rh, C or combinations thereof

21. The MEA structure as claimed in claim 3, wherein the CO conversion catalyst layer has a thickness of about 10-100 μm.

22. The MEA structure as claimed in claim 3, wherein the CO conversion catalyst layer is porous structure having a pore diameter of about 0.03-0.5 μm and a porosity of about 0.4-0.9.

23. The MEA structure as claimed in claim 1, wherein the MEA structure is applicable in a proton exchange membrane fuel cell (PEMFC).

24. A method for fabricating a membrane electrode assembly (MEA) structure, comprising:
providing a proton exchange membrane having opposite first and second sides;
providing and disposing a first composite gas diffusion layer at the first side of the proton exchange membrane, wherein the first composite gas diffusion layer comprises a first gas diffusion substrate layer and a first micro-porous layer;
forming a cathode catalyst layer over the first micro-porous layer of the first composite gas diffusion layer;
providing and disposing a second composite gas diffusion layer at the second side of the proton exchange membrane, wherein the second composite gas diffusion layer comprises a second gas diffusion substrate layer and a second micro-porous layer;
forming an anode catalyst layer over the second micro-porous layer of the second composite gas diffusion layer; and
thermally compressing the first composite gas diffusion layer, the cathode catalyst layer, the proton exchange membrane, the anode catalyst layer and the second composite gas diffusion layer to form the MEA structure.

25. The method as claimed in claim 24, wherein providing the first composite gas diffusion layer comprises:
immersing the first gas diffusion substrate layer into a polytetrafluoroethene (PTFE) containing solution with a PTFE concentration of about 1-10 wt % until a defined saturated level is reached and then drying and thermally treating the saturated substrate layer under a temperature of 300-400° C. for 30 minutes;
coating the first micro-porous layer at a side of the first gas diffusion substrate layer; and
performing a thermal treatment under a temperature of about 350-450° C. for 30 minutes to provide the first composite gas diffusion layer.

26. The method as claimed in claim 24, wherein providing the second composite gas diffusion layer comprises:
immersing the second gas diffusion substrate layer into a polytetrafluoroethene (PTFE) containing solution with a PTFE concentration of about 1-10 wt % until a defined saturated level is reached and then drying and thermally treating the saturated substrate layer under a temperature of 300-400° C. for 30 minutes;
coating the second micro-porous layer at a side of the second gas diffusion substrate layer; and
performing a thermal treatment under a temperature of about 350-450° C. for 30 minutes to provide the second composite gas diffusion layer.

27. The method as claimed in claim 26, further comprises following two steps:
coating a carbon monoxide (CO) conversion catalyst layer over a side of second gas diffusion substrate layer opposing the second micro-porous layer; and
performing a thermal treatment to the CO conversion catalyst layer under a temperature of about 100-300° C. for 30 minutes to provide the second composite gas diffusion layer.

28. The method as claimed in claim 24, wherein the second composite gas diffusion layer further comprises a carbon monoxide (CO) conversion catalyst layer disposed between the second micro-porous layer and the second gas diffusion substrate layer, and method for fabrication comprises:
immersing the second gas diffusion substrate layer into a polytetrafluoroethene (PTFE) containing solution with a PTFE concentration of about 1-10 wt % until a defined saturated level is reached and then drying and thermally treating the saturated substrate layer under a temperature of 300-400° C. for 30 minutes;
coating a carbon monoxide catalyst layer over a side of the second gas diffusion substrate layer treated by the PTFE containing solution;
coating the second micro-porous layer over the carbon monoxide catalyst layer; and
performing a thermal treatment under a temperature of about 350-450° C. for 30 minutes to provide the second composite gas diffusion layer.

29. The method as claimed in claim 24, wherein providing the second composite gas diffusion layer comprises:
immersing the second gas diffusion substrate layer into a polytetrafluoroethene (PTFE) containing solution with a PTFE concentration of about 1-10 wt % until a defined saturated level is reached and then drying and thermally treating the saturated substrate layer under a temperature of 300-400° C. for 30 minutes;
immersing the second gas diffusion substrate layer treated by the PTFE containing solution into a carbon monoxide (CO) conversion catalyst containing solution until a defined saturated level is reached and then drying thereof;
performing a thermal treatment under a temperature of about 100-300° C. for 30 minutes;
coating the second micro-porous layer over a side of the second gas diffusion substrate layer treated by the PTFE containing solution and the CO conversion catalyst containing solution; and
performing a thermal treatment under a temperature of about 350-450° C. for 30 minutes to provide the second composite gas diffusion layer.
